(19) United States
(12) Patent Application Publication
(10) Pub. No.: US 2025/0319917 A1
(43) Pub. Date: Oct. 16, 2025

(54) ITEM MOVING CART HAVING CONVEYOR BUILT THEREIN

(71) Applicant: Hwa young JUNG, Changwon-si (KR)

(72) Inventor: Hwa young JUNG, Changwon-si (KR)

(21) Appl. No.: 19/175,974

(22) Filed: Apr. 10, 2025

(30) Foreign Application Priority Data
Apr. 12, 2024 (KR) KR10-2024-0049207

(51) Int. Cl. B62B 3/04; B65G 15/30; B65G 41/00

(52) U.S. Cl. CPC B62B 3/04; B65G 15/30; B65G 41/008; B65G 2812/02287

(57) ABSTRACT

The present disclosure relates to an item moving cart that moves, while receiving given items therein, to transfer the items along fixed paths, more specifically to an item moving cart having conveyors built therein that is capable of allowing items to be loaded on tops of the conveyors so that if the item moving cart completely moves to a given place, the conveyors operate through the application of power to the item moving cart to allow the items to be unloaded from the item moving cart to the outside.

### BACKGROUND OF THE DISCLOSURE

### CROSS REFERENCE TO RELATED APPLICATION OF THE DISCLOSURE

The present application claims the benefit of Korean Patent Application No. 10-2024-0049207 filed in the Korean Intellectual Property Office on Apr. 12, 2024 the entire contents of which are incorporated herein by reference.

### Field of the Disclosure

The present disclosure relates to an item moving cart that moves, while receiving given items therein, to transfer the items along fixed paths, more specifically to an item moving cart having conveyors built therein that is capable of allowing items to be loaded on tops of the conveyors so that if the item moving cart completely moves to a given place, the conveyors operate through the application of power to the item moving cart to allow the items to be unloaded from the item moving cart to the outside.

### Background of the Related Art

Generally, a cart is used to transport given items in a workplace where the given items are repeatedly produced, and such a cart moves by means of an autonomous mobile robot (AMR) or automated guided vehicle (AGV). If the cart has moved after the items are loaded thereinto, in detail, the items are unloaded from the cart to the outside by means of a robot or worker, thereby seriously increasing production and labor costs.

One of conventional technologies relating to a cart used in an item production site such as a factory is disclosed in Korean Patent No. 10-1973245 entitled ‘unmanned automated moving cart’.

The conventional unmanned automated moving cart includes: a body in which loads are seated; casters disposed on four positions of the underside of the body to move the body; a driving device disposed on the underside of the body to supply power so that the body automatically moves forward and backward; fixing devices disposed on the front and rear sides of the underside of the body in such a way as to move down at a time point when the body returns while reciprocating a given area to allow the movement of the body that occurs when the body comes into close contact with a floor to be reduced to prevent the body from escaping from its moving path; a guide sensor disposed on at least one of the body and the driving device to sense a magnetic guide located on the moving path; and a controller disposed on one side of the body to control operations for movement such as the operations of the driving device and the fixing device so that the body moves along the magnetic guide sensed by the guide sensor, wherein the driving device includes: an upper plate coupled to the underside of the body; a lower plate located on the underside of the upper plate; a support shaft disposed inside the lower plate in both directions; driving wheels rotatably mounted on both sides of the support shaft; first and second driving motors mounted on the lower plate to transmit power to the driving wheels; and a suspension whose upper end portion is rotatably coupled to the upper plate and lower end portion is coupled to the support shaft located inside the lower plate in such a way as to suppress the movements and fluctuations occurring during the movement of the body, the suspension having a close contact plate with upwardly slant surfaces on both end portions thereof, the close contact plate being located on a lower portion thereof in such a way as to be brought into close contact with the top surface of the support shaft to allow the support shaft to be movable within angles of the slant surfaces. In this case, the cart moves along the magnetic guide sensed through the guide sensor, and therefore, such a magnetic guide has to be additionally mounted along the moving path of the cart. Further, the first and second driving motors for moving the cart and the suspension for allowing the support shaft to move are needed, thereby greatly increasing the manufacturing cost of the cart and requiring additional power storage device such as batteries for operating the driving motors.

Another conventional technology relating to a cart is disclosed in Korean Utility Model Registration No. 20-0359213 entitled ‘monorail moving cart’.

The conventional monorail moving cart includes a driving wheel mounted on the underside of a frame on one side of the frame, so that the cart moves along a moving rail, and a caster mounted on the other side of the frame in such a way as to face the driving wheel. In this case, a monorail is additionally built to move the moving cart, and therefore, it is impossible that the moving cart is used in a place where the monorail cannot be built. Further, the moving cart cannot move in a place where the monorail is not built. Therefore, the conventional monorail moving cart is very limited in an area where it can move.

### SUMMARY OF THE DISCLOSURE

Accordingly, the present disclosure has been made in view of the above-mentioned problems occurring in the related art, and it is an object of the present disclosure to provide an item moving cart having conveyors built therein that is capable of allowing items to be loaded on tops of the conveyors so that if the item moving cart completely moves to a given place, the conveyors operate through the application of power to the item moving cart to allow the items to be unloaded from the item moving cart to the outside.

It is another object of the present disclosure to provide an item moving cart having conveyors built therein that is capable of allowing the conveyors to be arranged in two rows when viewed in a moving direction of the item moving cart, so that according to the sizes and shapes of items, the items are unloaded by using either of the two row conveyors, sequentially using the two row conveyors, or simultaneously using both of them, thereby maximizing the utility of the conveyors.

It is yet another object of the present disclosure to provide an item moving cart having conveyors built therein that is capable of having a power outlet detachable from a power outlet disposed on a given device, so that if the power outlet of the given device and the power outlet of the item moving cart are coupled to each other, power is applied to the conveyors to allow the conveyors to operate, and therefore, there is no need to have batteries for power supply, thereby reducing the weight of the item moving cart.

To accomplish the above-mentioned objects, according to the present disclosure, there is provided an item moving cart having conveyors built therein to move given items, the item moving cart including: a body; a main frame fixed to the body to support the body; casters disposed on the underside of the main frame to move the item moving cart; a top cover disposed on a top of the body and having doors adapted to allow given items to be received in the body, and the conveyors disposed on an upper portion of the body to allow the given items received in the body to be unloaded from the body to the outside.

### BRIEF DESCRIPTION OF THE DRAWINGS

The above and other items, features and advantages of the present disclosure will be apparent from the following detailed description of the embodiments of the disclosure in conjunction with the accompanying drawings, in which:

FIG. 1 is a perspective view showing an item moving cart having conveyors built therein according to the present disclosure;

FIG. 2 is a perspective view showing the item moving cart having conveyors built therein according to the present disclosure, in which a top cover is removed;

FIG. 3 is a perspective view showing the conveyor according to the present disclosure;

FIG. 4 is a plan view showing the conveyor according to the present disclosure;

FIG. 5 is a side view showing the conveyor according to the present disclosure;

FIG. 6 is a perspective view showing an anti-back unit according to the present disclosure; and

FIG. 7 is a perspective view showing a portion of the item moving cart having conveyors built therein according to the present disclosure.

### DETAILED DESCRIPTION OF THE PREFERRED EMBODIMENT

The present disclosure relates to an item moving cart that moves, while receiving given items therein, to transfer the items along fixed paths, more specifically to an item moving cart having conveyors built therein that is capable of allowing items to be loaded on tops of the conveyors so that if the item moving cart completely moves to a given place, the conveyors operate through the application of power to the item moving cart to allow the items to be unloaded from the item moving cart to the outside.

Hereinafter, an embodiment of the present disclosure will be explained in detail with reference to the attached drawings.

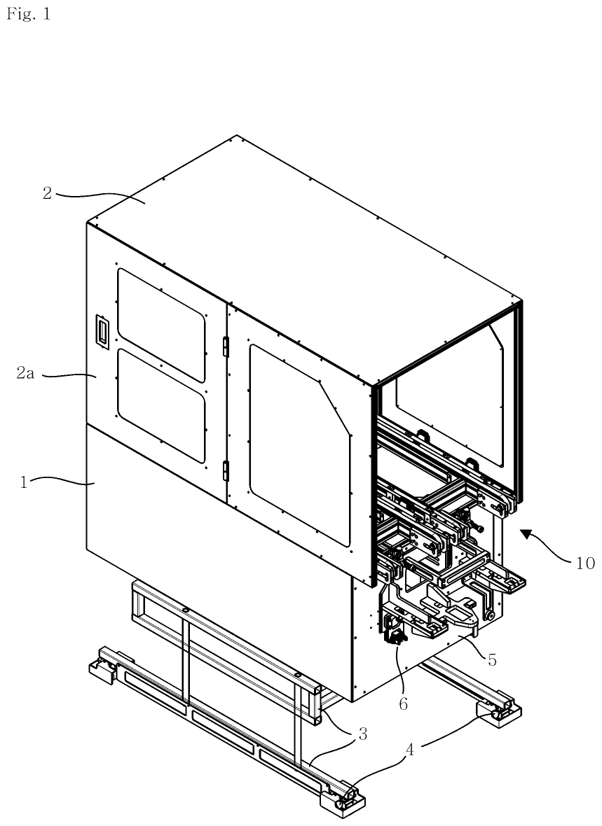

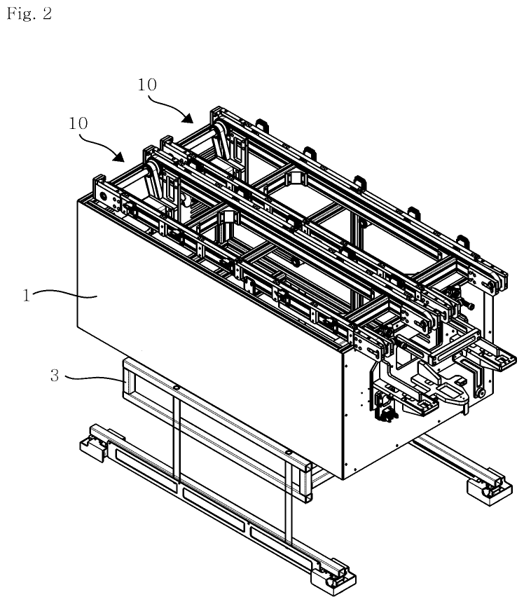

FIG. 1 is a perspective view showing an item moving cart having conveyors built therein according to the present disclosure, and FIG. 2 is a perspective view showing the item moving cart having conveyors built therein in which a top cover is removed. An item moving cart having conveyors built therein according to the present disclosure includes a body 1, a main frame 3 fixed to the body 1 to support the body 1, casters 4 disposed on the underside of the main frame 3 to move the item moving cart, a top cover 2 disposed on a top of the body 1 and having doors 2a adapted to allow given items to be received in the body 1, and the conveyors 10 disposed on an upper portion of the body 1 to allow the given items received in the body 1 to be unloaded from the body 1 to the outside.

First, the body 1 is a basic component of the item moving cart, and according to the embodiment of the present disclosure, the body 1 has the shape of a hexahedron open on top thereof. The main frame 3 is fixed to the body 1 and thus supports the body 1, and the casters 4 are disposed on the underside of the main frame 3 to move the item moving cart. According to the embodiment of the present disclosure, four casters 4 are provided. The top cover 2 is disposed on the top of the body 1 and has the doors 2a adapted to allow the given items to be received in the body 1, and the conveyors 10 are disposed on an upper portion of the body 1 to allow the given items received in a space formed by the body 1 and the top cover 2 to be loaded or unloaded to or from the body 1.

After the item moving cart has moved to a given place, if it is desired that the items are loaded to the item moving cart, the conveyors 10 operate to load the items onto the item moving cart. Contrarily, after the item moving cart with the items loaded thereonto has moved to a given place, the conveyors 10 operate to unload the items from the item moving cart.

Further, the conveyors 10 are arranged in two rows when viewed from the front in a moving direction of the item moving cart, so that the two row conveyors simultaneously operate, and otherwise, after one row conveyor operates to unload the items from the body 1, the other row conveyor operates to unload the items from the body 1 sequentially.

In detail, the conveyors 10 are arranged in parallel to each other in two rows when viewed in a moving direction of the item moving cart, so that either of the two row conveyors operates or both of them operate. Under such an operating way, either of the two row conveyors operates to load or unload the items, and if necessary, the two row conveyors operate simultaneously to load or unload the items. If the items are relatively big in size, both of the two row conveyors operate to load or unload the items.

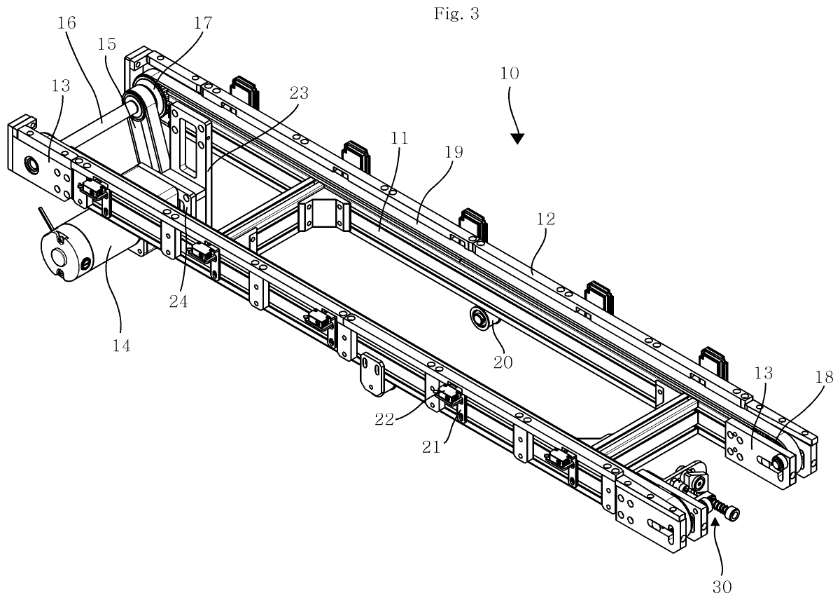

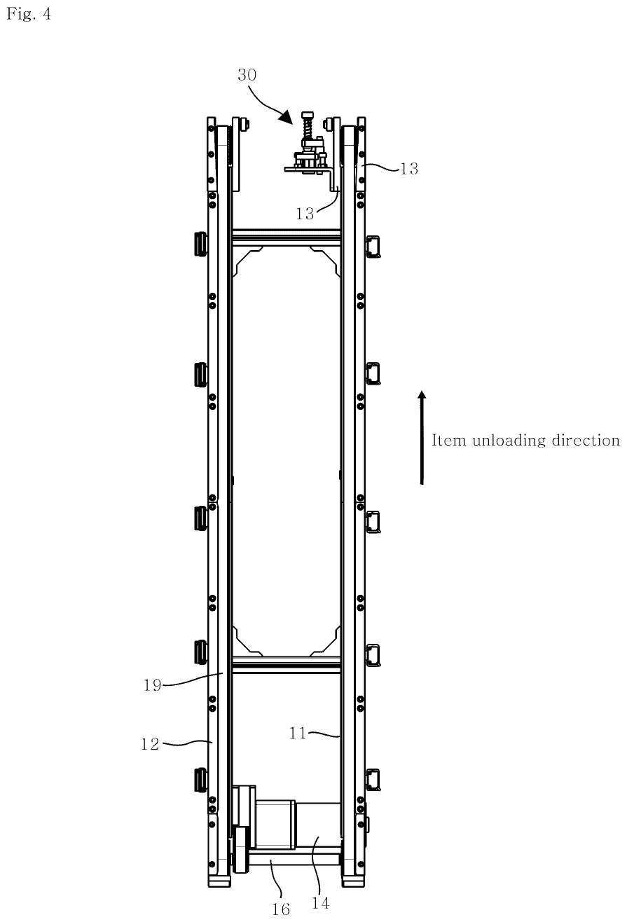

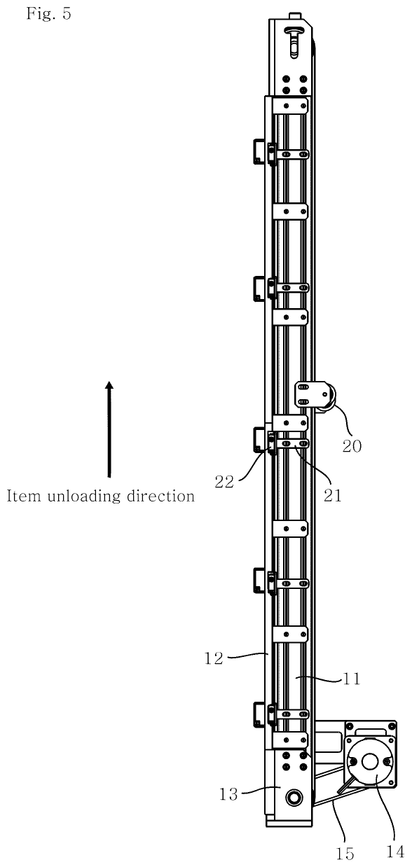

FIG. 3 is a perspective view showing the conveyor according to the present disclosure, FIG. 4 is a plan view showing the conveyor according to the present disclosure, and FIG. 5 is a side view showing the conveyor according to the present disclosure. The conveyor 10 includes base frames 11, guide plates 12 fixedly disposed on tops of the base frames 11, fixing plates 13 disposed on both ends of the base frames 11, a driving shaft 16 supported against the fixing plates 13 and rotating, driving pulleys 17 coupled to both sides of the driving shaft 16, driven pulleys 18 disposed spaced apart from the driving pulleys 17 by a given distance, a driving motor 14 disposed on one side of the base frames 11, a driving belt 15 for transferring the power generated from the driving motor 14 to the driving shaft 16, and conveyor belts 19 disposed between the driving pulleys 17 and the driven pulleys 18 and thus performing endless linear motions to rotate the driven pulleys 18 according to the rotations of the driving pulleys 17, and in this case, the fixing plates 13 are varied in positions coupled to the base frames 11 to allow the tension applied to the conveyor belts 19 to be adjusted.

First, the base frames 11 are basic frames of the conveyor 10, and the guide plates 12 are located on the tops of the base frames 11 to prevent the items moving along the conveyor belts 19 from falling down. The fixing plates 13 are disposed on both ends of the base frames 11 to support the pulleys rotating by means of the conveyor belts 19, and the driving shaft 16 is supported against the driving pulleys 17 coupled to the fixing plates 13 and thus rotates. The driving pulleys 17 are coupled to both sides of the driving shaft 16 and thus rotate together with the driving shaft 16, and the driven pulleys 18 are disposed spaced apart from the driving pulleys 17 by the given distance and rotate with the power transferred through the rotations of the driving pulleys 17. The driving motor 14 is disposed on one side of the base frames 11 and generates a rotational force if power is applied thereto, and the driving belt 15 rotates by means of a driving shaft of the driving motor 14 and thus transfers the rotational power generated from the driving motor 14 to the driving shaft 16. The conveyor belts 19 are disposed between the driving pulleys 17 and the driven pulleys 18 and thus transfer the rotational forces of the driving pulleys 17 to the driven pulleys 18, and in this case, the items to be required to move in the item moving cart move according to the rotations of the conveyor belts 19. The fixing plates 13 are varied in positions coupled to the base frames 11 to allow the tension applied to the conveyor belts 19 to be adjusted.

Referring to the order of power transfer, if the power is applied to the driving motor 14, the driving shaft of the driving motor 14 rotates to allow a motor pulley coupled to the driving shaft to rotate, and next, the driving belt 15 rotates by means of the rotation of the motor pulley to allow the driving shaft 16 coupled to the driving pulleys 17 to rotate. Sequentially, the conveyor belts 19 rotate by means of the rotations of the driving pulleys 17 to allow the driven pulleys 18 to rotate. As a result, the items placed on tops of the conveyor belts 19 are unloaded from the item moving cart to the outside by means of the rotations of the conveyor belts 19.

Further, an anti-back unit 30 is located on one side of the fixing plate 13 to prevent the received items from being unloaded from the item moving cart to the outside even if the conveyor belts 19 rotate.

In detail, a typical anti-back unit is used for a conveyance device to prevent a pallet from being transferring back in a conveyance line of a conveyor line, but according to the present disclosure, the anti-back unit 30 of the conveyor 10 is located on one side of the fixing plate 13 and serves as a stopper for preventing the received items from being unloaded from the item moving cart to the outside, while the item moving cart is moving.

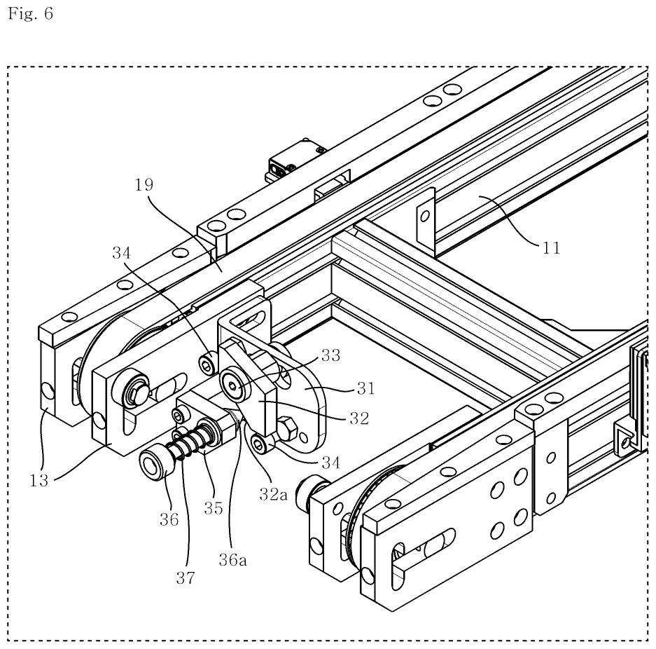

FIG. 6 is a perspective view showing an anti-back unit according to the present disclosure. The anti-back unit 30 includes an anti-back fixed plate 31 fixedly coupled to the fixing plate 13, a rotational plate 32 coupled to the anti-back fixed plate 31 by means of a hinge 33 in such a way as to be rotatable within a given range around the hinge 33, stoppers 34 disposed on the anti-back fixed plate 31 to limit the rotational amount of the rotational plate 32, a guide block 35 fixed to the anti-back fixed plate 31, a driving bar 36 coupledly passing through a through hole formed on the guide block 35, and a spring 37 disposed between the driving bar 36 and the guide block 35. The driving bar 36 has a conical portion 36a formed on one end thereof, and the rotational plate 32 has a slant surface 32a with a given inclination angle, so that if an external force is applied in a direction of compressing the spring 37, the driving bar 36 moves toward the rotational plate 32 and thus rotates the rotational plate 32 to allow the items seated on tops of the conveyor belts 19 to be unloaded from the item moving cart.

First, the anti-back fixed plate 31 is fixed to the fixing plate 13, and the rotational plate 32 is coupled to the anti-back fixed plate 31 by means of the hinge 33 in such a way as to be rotatable in a clockwise or counterclockwise direction within the given range around the hinge 33. If the rotational plate 32 rotates to the maximum in the clockwise direction, as shown in FIG. 6, a portion of the rotational plate 32 becomes higher in height than the tops of the conveyor belts 19 to prevent the items seated on tops of the conveyor belts 19 from being unloaded from the item moving cart to the outside, and the stoppers 34 are disposed on the anti-back fixed plate 31 to limit the rotational amount of the rotational plate 32. According to the embodiment of the present disclosure, the stoppers 34 are located on left and right sides around the hinge 33. The guide block 35 is located in front of the anti-back fixed plate 31 in the moving direction of the item moving cart, and the driving bar 36 coupledly passes through the through hole formed on the guide block 35. The spring 37 is compressed by means of the external force applied in a direction of moving the driving bar 36 toward the anti-back fixed plate 31 and allows the driving bar 36 to move in a direction of being distant from the anti-back fixed plate 31 by means of an elastic force thereof if the external force is removed. The conical portion 36a is formed on one end of the driving bar 36 in such a way as to become small in a cross-sectional area toward the outside thereof and thus come into close contact with the slant surface 32a of the rotational plate 32.

If the driving bar 36 moves toward the anti-back fixed plate 31 by means of the application of the external force, the conical portion 36a of the driving bar 36 comes into close contact with the slant surface 32a of the rotational plate 32 to allow the rotational plate 32 to rotate in the counterclockwise direction by means of the shape thereof, so that the portion of the rotational plate 32 that is exposed above the tops of the conveyor belts 19 disappears to allow the items seated on tops of the conveyor belts 19 to freely move.

In this case, the external force for pushingly moving the driving bar 36 toward the anti-back fixed plate 31 is generated by means of the movement of the item moving cart.

In detail, if the item moving cart with the items loaded thereonto moves toward a conveyor (not shown) of an automation line for moving the items, the driving bar 36 of the item moving cart is brought into close contact with a counterpart of the conveyor of the automation line, so that the driving bar 36 moves toward the anti-back fixed plate 31 to allow the rotational plate 32 to rotate in the counterclockwise direction, thereby performing unloading of the items from the item moving cart.

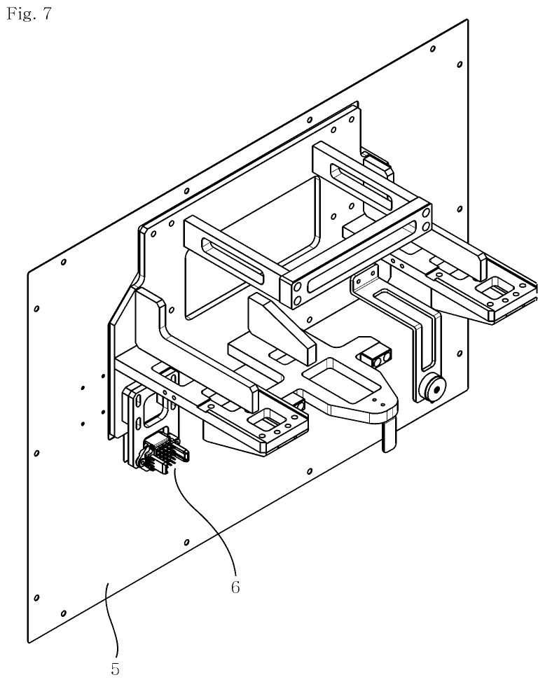

FIG. 7 is a perspective view showing a portion of the item moving cart having the conveyors built therein according to the present disclosure, and the item moving cart has a power outlet 6 detachable from a power outlet disposed on a given device, and if the power outlet of the given device and the power outlet 6 are coupled to each other, the power is applied to the driving motor 14 of the conveyor 10 of the item moving cart so that the conveyor 10 can operate.

In detail, the item moving cart has a fixing plate 5 with components for docking with the conveyor of the automation line, and the fixing plate 5 has the power outlet 6 for supplying the power. If the item moving cart moves to the conveyor of the automation line for moving the items, the power outlet disposed on the conveyor of the automation line moves to the power outlet 6 so that the power outlets are electrically connected to each other, and through the electrical connection between the power outlets, external power is supplied to the item moving cart by means of a power line located on the conveyor of the automation line. Next, the power supplied to the item moving cart is used as power for driving the driving motor 14, and therefore, there is no need to have any power storage device in the item moving cart to drive the driving motor 14.

In this case, the item moving cart having the conveyors built therein according to the present disclosure is movable by means of an autonomous mobile robot (AMR) or automated guided vehicle (AGV), so that there is no need to have a power storage device such as batteries, thereby reducing the weight of the item moving cart and the power required for the movement of the item moving cart.

Reference numerals not explained yet are 21 representing sensor fixing brackets, 22 representing item sensors, 23 representing a motor fixing bracket, and 24 representing an adjusting bracket. The sensor fixing brackets 21 are fixed to the base frames 11 to fix the item sensors 22 to given positions, and the item sensors 22 are sensors for sensing the items existing in the item moving cart. The motor fixing bracket 23 is fixed to the base frames 11 to fix the driving motor 14 thereto, and the adjusting bracket 24 is fixed to the motor fixing bracket 23 in such a way as to be adjusted in fixed position to allow the tension of the driving belt 15 to be adjusted.

According to the above-mentioned embodiment of the present disclosure, the driving motors 14, which are disposed in parallel to the conveyors 10, are provided by conveyor, that is, according to the number of conveyors built in the item moving cart. In this case, the driving motors 14 of the respective conveyors 10 operate independently, thereby allowing the items to be smoothly loaded and unloaded and reducing the power as required for driving them.

As described above, the item moving cart having the conveyors built therein according to the present disclosure can allow the items to be loaded on tops of the conveyors so that if the item moving cart completely moves to a given place, the conveyors operate through the application of power to the item moving cart to allow the items to be discharged to the outside, thereby achieving complete automation in transferring and discharging the items.

Further, the item moving cart having the conveyors built therein according to the present disclosure can allow the conveyors to be arranged in two rows when viewed in a moving direction of the item moving cart, so that according to the sizes and shapes of items, the items are unloaded by using either of the two row conveyors, sequentially using the two row conveyors, or simultaneously using both of them, thereby maximizing the utility of the conveyors.

Furthermore, the item moving cart having the conveyors built therein according to the present disclosure can have the power outlet detachable from a power outlet disposed on a given device, so that if the power outlet of the given device and the power outlet of the item moving cart are coupled to each other, power is applied to the conveyors to allow the conveyors to operate, and therefore, there is no need to have batteries for power supply, thereby reducing the weight of the item moving cart.

While the present disclosure has been given with reference to the particular illustrative embodiments, it is not to be restricted by the embodiments but only by the appended claims. It is to be appreciated that those skilled in the art can change or modify the embodiments without departing from the scope and spirit of the present disclosure.

What is claimed is:

1. An item moving cart for moving given items, comprising:
a body (1);
a main frame (3) fixed to the body (1) to support the body (1);
casters (4) disposed on the underside of the main frame (3) to move the item moving cart;
a top cover (2) disposed on a top of the body (1) and having doors (2a) adapted to allow given items to be received in the body (1); and
conveyors (10) disposed on an upper portion of the body (1) to allow the given items received in the body (1) to be unloaded from the body (1) to the outside,
wherein each conveyor (10) comprises: base frames (11); guide plates (12) fixed to tops of the base frames (11); fixing plates (13) disposed on both ends of the base frames (11); a driving shaft (16) supported against the fixing plates (13) and rotating; driving pulleys (17) coupled to both sides of the driving shaft (16); driven pulleys (18) disposed spaced apart from the driving pulleys (17) by a given distance; a driving motor (14) disposed on one side of the base frames (11); a driving belt (15) for transferring power generated from the driving motor (14) to the driving shaft (16); and conveyor belts (19) disposed between the driving pulleys (17) and the driven pulleys (18) and thus performing endless linear motions to rotate the driven pulleys (18) according to the rotations of the driving pulleys (17), the fixing plates (13) being varied in positions coupled to the base frames (11) to allow the tension applied to the conveyor belts (19) to be adjusted, and
an anti-back unit (30) is located on one side of the fixing plate (13) to prevent the received items from being unloaded from the body (1) to the outside even if the conveyor belts (19) rotate, the anti-back unit (30) comprising: an anti-back fixed plate (31) fixedly coupled to the fixing plate (13); a rotational plate (32) coupled to the anti-back fixed plate (31) by means of a hinge (33) in such a way as to be rotatable within a given range around the hinge (33); stoppers (34) disposed on the anti-back fixed plate (31) to limit the rotational amount of the rotational plate (32); a guide block (35) fixed to the anti-back fixed plate (31); a driving bar (36) coupledly passing through a through hole formed on the guide block (35); and a spring (37) disposed between the driving bar (36) and the guide block (35), the driving bar (36) having a conical portion (36a) formed on one end thereof, and the rotational plate (32) having a slant surface (32a) with a given inclination angle, whereby if an external force is applied in a direction of compressing the spring (37), the driving bar (36) moves toward the rotational plate (32) and thus rotates the rotational plate (32) to allow the items seated on tops of the conveyor belts (19) to be unloaded from the body (1) to the outside.

2. The item moving cart according to claim 1, wherein the conveyors (10) are arranged in two rows when viewed in a moving direction of the item moving cart, so that the two row conveyors operate simultaneously to unload the items, and otherwise, the two row conveyors operate sequentially to unload the items.

3. The item moving cart according to claim 1, wherein if an external force applied in a direction of compressing the spring (37) is removed by means of the movement of the item moving cart, the driving bar (36) moves to a direction distant from the rotational plate (32) by means of an elastic force of the spring (37), so that the rotational plate (32) rotates to a given direction by means of a load thereof to allow a portion thereof to be exposed above the tops of the conveyor belts (19) and thus prevent the items seated on tops of the conveyor belts (19) from being unloaded from the body (1).

4. The item moving cart according to claim 1, further comprising a power outlet (6) detachable from a power outlet disposed on a given device, so that if the power outlet of the given device and the power outlet (6) are coupled to each other, the power is applied to the driving motor (14) of the conveyor (10) so that the conveyor (10) operates.
